(19) United States
(12) Patent Application Publication
(10) Pub. No.: US 2012/0002105 A1
(43) Pub. Date: Jan. 5, 2012

(54) Video Signal Interpolation Device, Video Display Device, and Video Signal Interpolation Method

(76) Inventors: Keiko Hirayama, Tokyo (JP); Himio Yamauchi, Kanagawa (JP)

(21) Appl. No.: 13/108,517

(22) Filed: May 16, 2011

(30) Foreign Application Priority Data
Jun. 30, 2010 (JP) 2010-149869

(51) Int. Cl. H04N 7/01

(52) U.S. Cl. 348/441; 348/E07.003

(57) ABSTRACT

According to one embodiment, a video signal interpolation device includes a motion vector detector, an interpolation frame generator, an analyzer, and an enhancer. The motion vector detector detects a motion vector from two consecutive image frames. The interpolation frame generator generates an interpolation frame from the image frames based on the motion vector detected by the motion vector detector. The analyzer detects uniform motion in a predetermined direction from the motion vector detected by the motion vector detector. The enhancer performs an enhancement process on the interpolation frame from the same direction as the direction of the uniform motion detected by the analyzer.

### CROSS-REFERENCE TO RELATED APPLICATIONS

This application is based upon and claims the benefit of priority from Japanese Patent Application No. 2010-149869, filed Jun. 30, 2010, the entire contents of which are incorporated herein by reference.

### FIELD

Embodiments described herein relate generally to a video signal interpolation device, a video display device, and a video signal interpolation method.

### BACKGROUND

Generally, a liquid crystal display (LCD) and the like has a frame interpolation function to display the motion of a video image smoothly. With the frame interpolation function, an interpolation frame is generated from a video signal input frame by frame, and video signals of input frames and those of interpolation frames are alternately displayed at double speed.

To generate such an interpolation frame, there has been known a conventional technology using a motion vector by detecting the motion of an object in two temporally consecutive image frames as the motion vector. Besides, in the conventional technology, a histogram is generated that indicates the occurrence frequency of each motion vector, and a motion vector the occurrence frequency of which is within a predetermined range is extracted from the histogram.

With the conventional technology, if uniform motion in a predetermined direction exists between the two temporally consecutive image frames due to pan or tilt, image blur may appear in an interpolation frame generated from the uniform motion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a video signal interpolation device according to an embodiment;

FIG. 2 is an exemplary schematic diagram of a vector histogram generated by a vector histogram generator in the embodiment;

FIG. 3 is an exemplary schematic diagram for explaining an enhancement process performed by an enhancer in the embodiment;

FIG. 4 is an exemplary schematic diagram for explaining another enhancement process performed by the enhancer in the embodiment;

FIG. 5 is an exemplary flowchart of a video signal interpolation process in the embodiment; and

FIG. 6 is an exemplary block diagram of a television broadcast receiver comprising the video signal interpolation device in the embodiment.

### DETAILED DESCRIPTION

Various embodiments will be described hereinafter with reference to the accompanying drawings. In general, according to one embodiment, a video signal interpolation device comprises a motion vector detector, an interpolation frame generator, an analyzer, and an enhancer. The motion vector detector is configured to detect a motion vector from two consecutive image frames. The interpolation frame generator is configured to generate an interpolation frame from the image frames based on the motion vector detected by the motion vector detector. The analyzer is configured to detect uniform motion in a predetermined direction from the motion vector detected by the motion vector detector. The enhancer is configured to perform an enhancement process on the interpolation frame from the same direction as the direction of the uniform motion detected by the analyzer.

According to another embodiment, a video display device is configured to display a video signal and comprises a motion vector detector, an interpolation frame generator, an analyzer, an enhancer, and a display module. The motion vector detector is configured to detect a motion vector from two consecutive image frames of the video signal. The interpolation frame generator is configured to generate an interpolation frame from the image frames based on the motion vector detected by the motion vector detector. The analyzer is configured to detect uniform motion in a predetermined direction from the motion vector detected by the motion vector detector. The enhancer is configured to perform an enhancement process on the interpolation frame from the same direction as the direction of the uniform motion detected by the analyzer. The display module is configured to display the video signal in which the interpolation frame is interpolated between the image frames.

According to still another embodiment, there is provided a video signal interpolation method comprising: detecting, by a motion vector detector, a motion vector from two consecutive image frames; generating, by an interpolation frame generator, an interpolation frame from the image frames based on the motion vector detected by the motion vector detector; detecting, by an analyzer, uniform motion in a predetermined direction from the motion vector detected by the motion vector detector; and performing, by an enhancer, an enhancement process on the interpolation frame from a direction equal to the direction of the uniform motion detected by the analyzer.

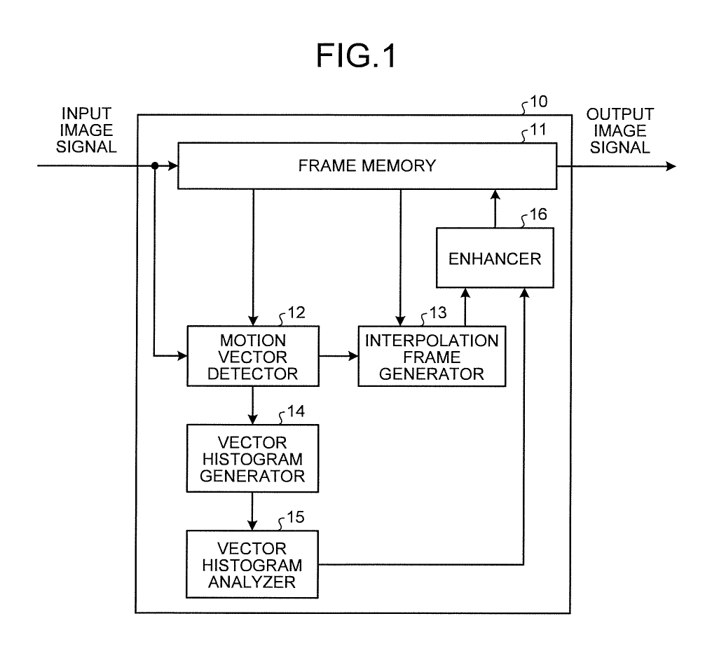

FIG. 1 is a block diagram of a video signal interpolation device 10 according to an embodiment. As illustrated in FIG. 1, the video signal interpolation device 10 comprises a frame memory 11, a motion vector detector 12, an interpolation frame generator 13, a vector histogram generator 14, a vector histogram analyzer 15, and an enhancer 16.

The frame memory 11 stores an input image signal received from an external device frame by frame. The frame rate of the input image signal is, for example, 60 frames per second.

The motion vector detector 12 detects a motion vector from two consecutive frames, i.e., a current frame that is an image frame received not through the frame memory 11 and a previous frame that is an image frame stored in the frame memory 11, using a known block matching technique. The motion vector detector 12 outputs the detected motion vector to the interpolation frame generator 13 and the vector histogram generator 14.

The interpolation frame generator 13 generates an interpolation frame from the current frame and the previous frame based on the detection result (the motion vector) obtained by the motion vector detector 12. The interpolation frame generator 13 then outputs the interpolation frame to the enhancer 16. The interpolation frame can be generated using a known technology.

The vector histogram generator 14 generates a histogram (hereinafter, “vector histogram”) from the motion vector detected by the motion vector detector 12, and outputs it to the vector histogram analyzer 15. The vector histogram is generated by calculating the occurrence frequency (vector frequency) of each of the same motion vectors with respect to the vertical and horizontal directions of an image frame.

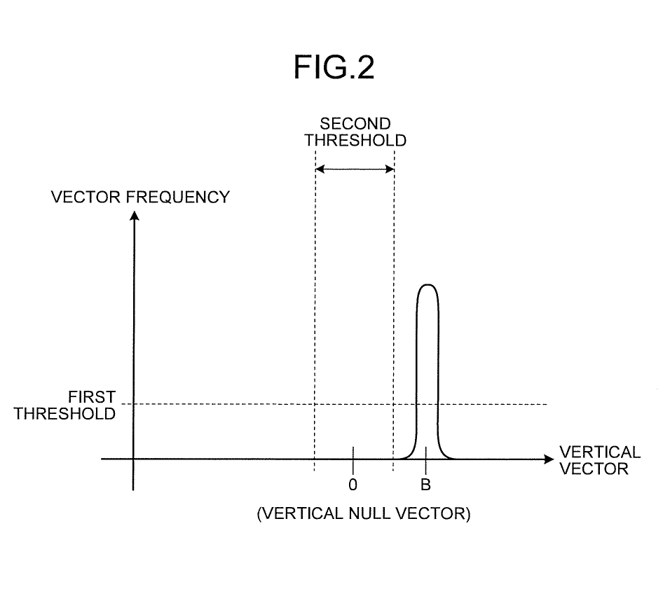

FIG. 2 illustrates an example of a vector histogram generated from a vertical motion vector. In FIG. 2, the horizontal axis represents vector quantity with respect to the vertical direction of the motion vector, and a position “0” (vertical null vector) corresponds to motionless state. Meanwhile, the vertical axis represents the number of motion vectors (vector frequency) having the same vector quantity. While FIG. 2 illustrates an example of a vector histogram of a vertical motion vector, similarly, a vector histogram is generated with respect to a horizontal motion vector.

Referring back to FIG. 1, the vector histogram analyzer 15 analyzes the vector histogram generated by the vector histogram generator 14 to make a determination (hereinafter, “motion determination”) on whether uniform motion occurs in the vertical direction and/or the horizontal direction. The uniform motion indicates that the distribution of vector frequencies concentrates on a specific vector quantity, which is caused by pan or tilt when an input image signal is captured.

For example, from the vector histogram illustrated in FIG. 2, the vector histogram analyzer 15 detects that vector frequencies concentrate on a position B of the vertical vector. In this case, the vector histogram analyzer 15 determines that the motion of a vector quantity corresponding to the position B uniformly occurs all over the area of a frame.

The range of the vector quantity and the minimum value of the vector frequency for the motion determination may be specified using a predetermined threshold. For example, in the case of the vector histogram illustrated in FIG. 2, the motion determination may be made for only vertical vectors with a vector frequency equal to or more than a first threshold. If a predetermined threshold range (a second threshold) is set around the vertical null vector, the motion determination may not be made for motion vectors of a vector quantity within the second threshold.

Having detected the uniform motion in the horizontal/vertical direction by the motion determination, the vector histogram analyzer 15 generates a control signal instructing to perform an enhancement process, which will be described later, at an intensity corresponding to the size of the motion from the same direction as the direction of the motion. The vector histogram analyzer 15 then outputs the control signal to the enhancer 16. The term “size of motion” as used herein refers to the absolute value of the vector quantity where the uniform motion is detected. Preferably, the intensity of the enhancement process is increased as the size of the motion increases.

For example, when uniform motion is detected in the vertical direction, the vector histogram analyzer 15 outputs to the enhancer 16 a control signal instructing to perform the enhancement process at an intensity corresponding to the size of the motion in the vertical direction of a frame. When uniform motion is detected in the horizontal direction, the vector histogram analyzer 15 outputs to the enhancer 16 a control signal instructing to perform the enhancement process at an intensity corresponding to the size of the motion in the horizontal direction of a frame. When uniform motion is detected in the diagonal direction, the vector histogram analyzer 15 outputs to the enhancer 16 a control signal instructing to perform the enhancement process at an intensity corresponding to the size of the motion in both the horizontal and vertical directions of a frame. When uniform motion is detected in neither the horizontal nor the vertical direction, the vector histogram analyzer 15 outputs to the enhancer 16 a control signal instructing to perform the enhancement process at a normal intensity.

The enhancer 16 performs the enhancement process to enhance an interpolation frame received from the interpolation frame generator 13 according to the control signal output from the vector histogram analyzer 15. The enhancer 16 then stores the interpolation frame in the frame memory 11.

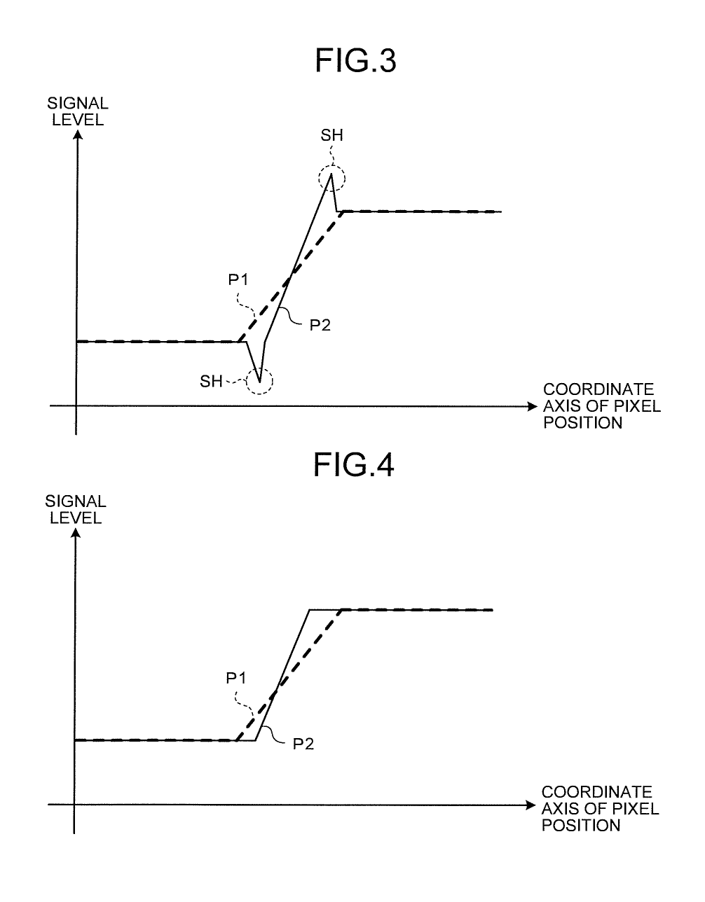

More specifically, upon receipt of a control signal from the vector histogram analyzer 15 that instructs to perform the enhancement process at a predetermined intensity in the horizontal direction of a frame, the enhancer 16 performs the enhancement process at the predetermined intensity from the horizontal direction of the interpolation frame. Besides, upon receipt of a control signal from the vector histogram analyzer 15 that instructs to perform the enhancement process at a predetermined intensity in the vertical direction of a frame, the enhancer 16 performs the enhancement process at the predetermined intensity from the vertical direction of the interpolation frame. In the following, the enhancement process of the enhancer 16 will be described with reference to FIGS. 3 and 4.

FIG. 3 is a diagram for explaining an example of the enhancement process performed by the enhancer 16. FIG. 4 is a diagram for explaining another example of the enhancement process performed by the enhancer 16. In FIGS. 3 and 4, the vertical axis represent the signal level, while the horizontal axis represents the coordinate axis of pixel position. Waveform P1 represents the brightness signal level of an interpolation frame near an edge of coordinates before the enhancement process. Waveform P2 represents the brightness signal level of an interpolation frame near an edge of coordinates after the enhancement process.

As illustrated in FIG. 3, the enhancer 16 adds a shoot component SH to an edge of a signal level contained in an interpolation frame by the enhancement process to sharpen the edge, thereby improving the sharpness of a video image. The direction (vertical/horizontal direction) in which the enhancement process is performed according to a control signal from the vector histogram analyzer 15 corresponds to a direction in which the edge of the signal level is detected. An intensity instructed by the control signal from the vector histogram analyzer 15 corresponds to a rising angle upon sharpening.

While FIG. 3 illustrates an example of the enhancement process in which an edge is sharpened by the addition of the shoot component SH, transient improvement may be performed as the enhancement process to sharpen the edge without the addition of the shoot component as illustrated in FIG. 4.

Referring back to FIG. 1, the frame memory 11 outputs video signals of stored image frames (previous frames) and those of interpolation frames alternately at double speed to output an output image signal in which an interpolation frame is interpolated between image frames. The frame rate of the output image signal is, for example, 120 frames per second.

The motion vector detector 12, the interpolation frame generator 13, the vector histogram generator 14, the vector histogram analyzer 15, and the enhancer 16 may each be implemented by a dedicated chip such as a microcontroller, or may be implemented by a single chip that integrates the functions of them. Alternatively, a predetermined computer program may be executed by the central processing unit (CPU) (not illustrated) to implement the above constituent elements as software.

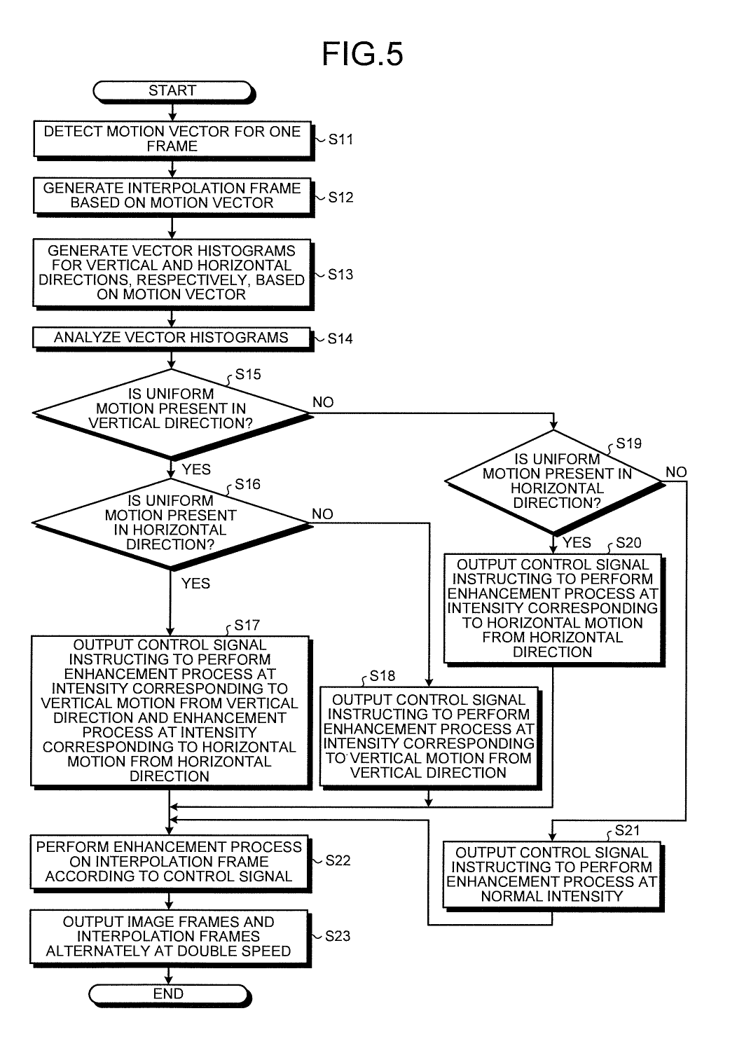

The operation of the video signal interpolation device 10 will be described with reference to FIG. 5. FIG. 5 is a flowchart of a video signal interpolation process performed by each constituent element of the video signal interpolation device 10.

First, when the video signal interpolation device 10 receives an input image signal from an external device, the motion vector detector 12 detects a motion vector for one frame (screen) from a current frame of the input image signal and a previous frame stored in the frame memory 11 (S11).

The interpolation frame generator 13 generates an interpolation frame based on the motion vector detected by the motion vector detector 12 (S12). Meanwhile, the vector histogram generator 14 generates vector histograms for the vertical direction and the horizontal direction, respectively, based on the motion vector detected by the motion vector detector 12 (S13).

The vector histogram analyzer 15 analyzes the vector histograms generated at S13 (S14), and determines whether uniform motion occurs in the vertical direction (S15). Having determined that uniform motion occurs in the vertical direction (Yes at S15), the vector histogram analyzer 15 determines whether uniform motion occurs in the horizontal direction (S16).

Having determined that uniform motion occurs also in the horizontal direction (Yes at S16), i.e., when uniform motion is detected in the diagonal direction, the vector histogram analyzer 15 outputs to the enhancer 16 a control signal instructing to perform the enhancement process at an intensity corresponding to the size of the vertical motion from the vertical direction and also the enhancement process at an intensity corresponding to the size of the horizontal motion from the horizontal direction (S17).

If uniform motion is not detected in the horizontal direction (No at S16), the vector histogram analyzer 15 outputs to the enhancer 16 a control signal instructing to perform the enhancement process at an intensity corresponding to the size of the vertical motion from the vertical direction (S18).

If uniform motion is not detected in the vertical direction (No at S15), the vector histogram analyzer 15 determines whether uniform motion occurs in the horizontal direction (S19). Having determined that uniform motion occurs in the horizontal direction (Yes at S19), the vector histogram analyzer 15 outputs to the enhancer 16 a control signal instructing to perform the enhancement process at an intensity corresponding to the size of the horizontal motion from the horizontal direction (S20).

If uniform motion is not detected in the horizontal direction (No at S19), the vector histogram analyzer 15 outputs to the enhancer 16 a control signal instructing to perform the enhancement process at a normal intensity (S21). The enhancement process at the normal intensity is the enhancement process at a predetermined intensity that the enhancer 16 performs in the normal operation, and serves as a reference to change the intensity.

The enhancer 16 performs the enhancement process on the high-frequency component of the interpolation frame received from the interpolation frame generator 13 according to the control signal output from the vector histogram analyzer 15 (S22). The enhancer 16 then stores the interpolation frame in the frame memory 11.

The frame memory 11 reads video signals of image frames (previous frames) and those of interpolation frames alternately at double speed to output an output image signal in which an interpolation frame is interpolated between image frames (S23). Then, the process ends.

As described above, according to the embodiment, in the video signal interpolation device 10, when the vector histogram analyzer 15 detects uniform motion in the vertical direction and/or the horizontal direction from vector histograms, the enhancer 16 performs the enhancement process corresponding to the size of the uniform motion from the same direction as the direction of the uniform motion. Thus, image (video) blur caused by pan, tilt, or the like can be effectively improved (reduced), and thereby a higher-quality interpolation frame can be generated.

While the intensity and the direction of the enhancement process are described above as being controlled frame by frame, it is not so limited. The intensity and the direction may be controlled with respect to each of blocks or each of pixels that constitute a frame. This control will be described below.

First, the motion vector detector 12 detects a motion vector from two consecutive frames, i.e., a current frame that is an image frame received not through the frame memory 11 and a previous frame that is an image frame stored in the frame memory 11 in units of blocks or pixels that constitute the frames. The vector histogram generator 14 generates vector histograms for the vertical direction and the horizontal direction, respectively, from the motion vector detected by the motion vector detector 12 in units of blocks or pixels.

The vector histogram analyzer 15 analyzes the vector histograms generated by the vector histogram generator 14 to make a motion determination. At this time, the vector histogram analyzer 15 sends the enhancer 16 a control signal specifying a block or a pixel having a motion vector of vector frequency determined to be uniform motion as the unit of the enhancement process with respect to each of the vertical and horizontal directions. As described above, the control signal instructs to perform the enhancement process at an intensity corresponding to the size of the uniform motion from the same direction as the direction of the uniform motion.

According to the control signal from the vector histogram analyzer 15, the enhancer 16 performs the enhancement process on an interpolation frame generated by the interpolation frame generator 13 in units of blocks or pixels that constitute the interpolation frame.

With this, the enhancement process can be performed in unit of block or pixel where uniform motion is detected at an intensity corresponding to the size of the motion from the same direction as the direction of the uniform motion. Thus, the same effect as previously described can be achieved.

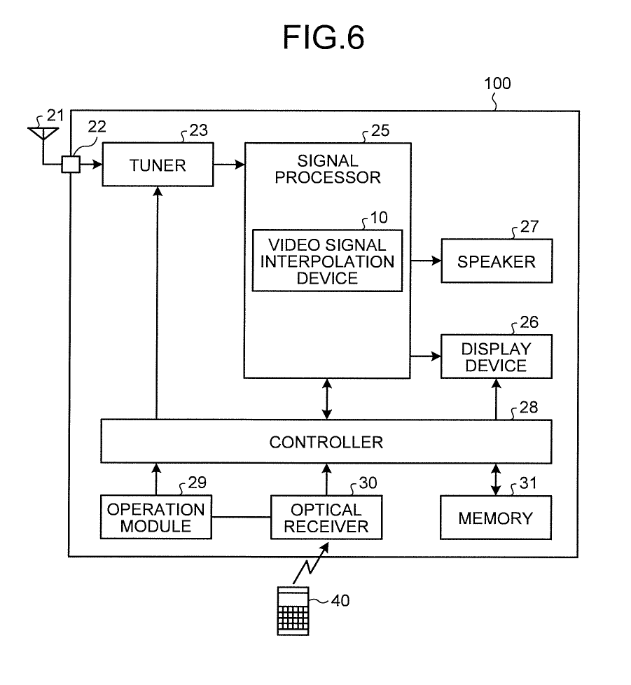

With reference to FIG. 6, an example will be described in which the video signal interpolation device 10 described above is applied to an image display device. While the video signal interpolation device 10 will be described below as being applied to a television (TV) broadcast receiver that receives a TV signal and displays the signal as the image display device, it is not so limited. The video signal interpolation device 10 may be applied to the recording of data on a large-capacity storage device such as a hard disk drive (HDD) and a digital versatile disc, a recorder/player that reproduces recorded data, a tuner, a set top box, and the like.

FIG. 6 is a block diagram of a TV broadcast receiver 100 comprising the video signal interpolation device 10. The video signal interpolation device 10 is provided in a signal processor 25 of the TV broadcast receiver 100.

In the TV broadcast receiver 100, an antenna 21 for receiving a digital TV broadcast receives a digital TV broadcast signal. The digital TV broadcast signal is fed to a tuner 23 via an input terminal 22. The tuner 23 selects a signal of a desired channel from the input digital TV broadcast signal and demodulates it. The tuner 23 then outputs the signal to the signal processor 25.

The signal processor 25 comprises the video signal interpolation device 10 and separates the signal received from the tuner 23 into a video signal, an audio signal, and the like. The video signal is input to the video signal interpolation device 10 as an input image signal. The respective constituent elements of the video signal interpolation device 10 perform the video signal interpolation process as described above, thereby outputting an output image signal in which an interpolation frame is interpolated to a display device 26. The display device 26 displays the output image signal.

The display device 26 may be a flat panel display such as a liquid crystal display (LCD), a plasma display, or the like. Besides, the signal processor 25 performs predetermined signal processing on the audio signal to convert it into an analog signal, and outputs it to a speaker 27. Thus, the audio is reproduced.

A controller 28 controls the overall operation of the TV broadcast receiver 100 including the receiving operation as described above. The controller 28 is a microprocessor comprising a built-in CPU or the like. The controller 28 receives operation information from an operation module 29 such as operation keys or operation information sent from a remote controller 40 via an optical receiver 30, and controls each constituent element based on the operation information. The controller 28 uses a memory 31. The memory 31 mainly comprises a read only memory (ROM), a random access memory (RAM), and a nonvolatile memory. The ROM stores a control program that is executed by the CPU. The RAM provides the CPU with a work area. The nonvolatile memory stores various types of setting information, control information, and the like.

The embodiment is susceptible to several modifications and variations. For example, while, in the embodiment, vector histograms are generated with respect to the vertical and horizontal directions of an image frame for the motion determination, it is not so limited. The vector histograms may be generated with respect to other directions for the motion determination.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal interpolation device comprising:
a motion vector detector configured to detect a motion vector from two consecutive image frames;
an interpolation frame generator configured to generate an interpolation frame from the image frames based on the motion vector detected by the motion vector detector;
an analyzer configured to detect uniform motion in a predetermined direction from the motion vector detected by the motion vector detector; and
an enhancer configured to perform an enhancement process on the interpolation frame from a direction equal to the direction of the uniform motion detected by the analyzer.

2. The video signal interpolation device of claim 1, wherein the enhancer is configured to perform the enhancement process at an intensity corresponding to a size of the uniform motion detected by the analyzer.

3. The video signal interpolation device of claim 1, wherein
the analyzer is configured to detect the uniform motion in the predetermined direction in unit of block or pixel that constitutes the image frames, and
the enhancer is configured to perform the enhancement process on the interpolation frame in the unit of block or pixel.

4. The video signal interpolation device of claim 1, further comprising a histogram generator configured to generate a histogram of the motion vector detected by the motion vector detector, wherein
the analyzer is configured to analyze the histogram generated by the histogram generator to detect the uniform motion in the predetermined direction.

5. The video signal interpolation device of claim 4, wherein
the histogram generator is configured to generate the histogram with respect to each of vertical direction and horizontal direction of the image frames, and
the analyzer is configured to detect a uniform motion vector in either or both the vertical direction and the horizontal direction from the histogram of the vertical direction and the histogram of the horizontal direction.

6. A video display device configured to display a video signal, comprising:
a motion vector detector configured to detect a motion vector from two consecutive image frames of the video signal;
an interpolation frame generator configured to generate an interpolation frame from the image frames based on the motion vector detected by the motion vector detector;
an analyzer configured to detect uniform motion in a predetermined direction from the motion vector detected by the motion vector detector;
an enhancer configured to perform an enhancement process on the interpolation frame from a direction equal to the direction of the uniform motion detected by the analyzer; and
a display module configured to display the video signal in which the interpolation frame is interpolated between the image frames.

7. The video display device of claim 6, further comprising a tuner configured to select a broadcast signal of a desired channel from broadcast signals received by an antenna, wherein
the motion vector detector is configured to detect a motion vector from each couple of consecutive image frames of the video signal contained in the broadcast signal.

8. A video signal interpolation method comprising:
detecting, by a motion vector detector, a motion vector from two consecutive image frames;
generating, by an interpolation frame generator, an interpolation frame from the image frames based on the motion vector detected by the motion vector detector;
detecting, by an analyzer, uniform motion in a predetermined direction from the motion vector detected by the motion vector detector; and
performing, by an enhancer, an enhancement process on the interpolation frame from a direction equal to the direction of the uniform motion detected by the analyzer.
